(19) United States
(12) Patent Application Publication
(10) Pub. No.: US 2002/0051220 A1
(43) Pub. Date: May 2, 2002

(54) Facsimile apparatus

(76) Inventors: Seiji Tanaka, Saga (JP); Yasushi Kida, Fukuoka (JP); Yoshinori Ikeguchi, Fukuoka (JP); Hirohiko Hirai, Fukuoka (JP)

Correspondence Address: RATNER AND PRESTIA, One Westlakes, Berwyn, Suite 301, P.O. Box 980, Valley Forge, PA, 19482-0980, US

(21) Appl. No.: 09/885,888

(22) Filed: Jun. 20, 2001

(30) Foreign Application Priority Data
Jun. 21, 2000 (JP) 2000-185852
Jun. 21, 2000 (JP) 2000-185853

(51) Int. Cl. H04N 1/00

(52) U.S. Cl. 358/400

(57) ABSTRACT

The disclosed facsimile apparatus stores data in a memory card through a communication line, and transfers image and other data to other terminal, image processing device, display unit or the like at a high picture quality through the memory card. A data memory unit stores the received data. A memory card input and output unit writes data into the memory card, and reads data from the memory card. The received data is stored in a data memory unit, and data reception information is displayed in a display unit. The user manipulates an input selector to select the data to be stored in the memory card from the data stored in the data memory unit and transfers to the memory card. Moreover, if necessary, the copyright is protected.

### FIELD OF THE INVENTION

The present invention relates to a facsimile apparatus, and more particularly to a facsimile apparatus capable of storing in a memory card by selecting from the data once stored in a data storage unit by receiving facsimile, or transmitting the data stored in the memory card by facsimile.

### BACKGROUND OF THE INVENTION

An ordinary facsimile apparatus is designed to scan a desired image by a scanner to take in the image information, and transmit the image, or receive the transmitted image and print or display.

Recently, a digital still camera is developed as an image input device into a personal computer, and various memory cards are used as the storing means of the still images. By inserting a memory card recording still images into a memory card slit, and reading, the image data can be taken into a personal computer.

If the image can be processed by the personal computer by using the memory card, to transmit the processed image to a remote place, once the image is printed out, and it is transmitted by the facsimile apparatus. That is, the stored electronic data is transferred onto paper as visible information, and it is put back to the electronic data, and the memory medium is not utilized effectively.

In such a method, conversion operations are repeated, and the resolution of the image is lowered.

On the other hand, the Internet is globally spreading rapidly to offer electronic services of distribution and settlement of image data and audio data. Such video data and audio data are obtained through a terminal of a personal computer or a mobile phone. These tools are, however, not familiar with elderly people or others, and they are isolated from these convenient services. At the present, one of the most popular data communication means is the facsimile apparatus. So far, however, the facsimile apparatus has not been regarded as a terminal for receiving such distribution data.

On the other hand, distributed data may be illegally copied, and protection of copyright of such distribution data is also an important problem. Once the distribution data can be obtained by the facsimile apparatus, it is not known whether the copyright can be protected or not.

The conventional facsimile apparatus is designed only to read and transmit the original image by using a scanner, and is not desired to transmit the image taken by a digital still camera directly from a memory card.

Considering the popularity of facsimile apparatus as data communication means, a wider use of the facsimile apparatus should be promoted.

### SUMMARY OF THE INVENTION

To improve the conventional apparatus, it is an object of the invention to present a facsimile apparatus capable of both storing the image data or audio data obtained through communication lines securely in a memory card, and transmitting the data stored in the memory card through communication lines, and moreover protecting the copyright if necessary.

To achieve the object, the facsimile apparatus of the invention comprises a communication input and output unit for transmitting and receiving data through a communication line, a data memory unit for storing data received in the communication input and output unit through the communication line, a display unit for displaying data reception information when data is stored in the data memory unit, a nonvolatile memory card detachable from the facsimile apparatus, a memory card input and output unit for loading a memory card and capable of writing data into the memory card and reading data from the memory card, and an input selector for selecting the data to be stored in the memory card from the data once stored in the data memory unit and transferring to the memory card.

In this configuration, image or audio data acquired through the communication line is once stored securely in the internal data memory unit, the reception information of the received data is displayed in the display unit, and the user can check and select only necessary data to store in the memory card securely, so that unnecessary data may not be stored in the memory card.

In this configuration, when memory card is not loaded in the memory card input and output unit, the control unit recognizes it and displays “Not installed” in the display unit.

It hence avoids the problem of the user noticing that the data is not transferred to the card after taking out the memory card.

In the case of input of transfer of data from the input selector, if the memory card is not installed in the memory card input and output unit, when the memory card is installed and it is recognized by the control unit, the data to be transferred can be transferred into the memory card.

After selecting the data to be stored, if it is known that the memory card is not installed, by inserting the memory card later, the data can be stored in the memory card without having to select again.

If the data received in the facsimile apparatus is different from the data format that can be entered in the memory card, a data format transform unit for transforming into an applicable data format may be further disposed. For example, if the data format applicable to the memory card is the JFIF (YCbCr color expression) data format of TIFF, it may be designed to transform into this format.

As the memory card, a copyright-protected memory card may be used, and the security of the received data is enhanced and the copyright can be protected.

The data stored in the memory card in such method may be transformed into a data format to be transmitted by facsimile in the data format transform unit, and can be transmitted through the communication line. In such configuration, the image taken by a digital still camera can be easily transmitted at high picture quality.

Further, to solve the conventional problems, it is also an object of the invention to present a facsimile apparatus capable of recording an image taken by a scanner easily into a memory card, transmitting an image taken by a digital still camera or an image taken by a scanner easily at high picture quality, storing the image data or audio data acquired through a communication line securely into a memory card, and protecting the copyright if necessary.

To achieve the object, the facsimile apparatus of the invention comprises a communication input and output unit for transmitting and receiving data through a communication line, a scanner for reading an original document or image data, a nonvolatile memory card detachable from the facsimile apparatus, a memory card input and output unit for loading a memory card and capable of writing data into the memory card and reading data from the memory card, a first data format transform unit for transforming input image data from the scanner into facsimile applicable data format, a second data format transform unit for transforming the data format mutually between facsimile applicable data format and memory card accessible data format, and a mode selector for sending the data issued from the first data format transform unit to the communication input and output unit in transmission mode, and feeding the data issued from the first data format transform unit into the second data format transform unit in recording mode.

In this configuration, the image recorded by the scanner can be easily recorded in the memory card, and the image taken by the digital still camera or the image read by the scanner can be easily transmitted at high picture quality.

Herein, the same effect is obtained if the function of the first data format transform unit is to transform the image data entered from the scanner into the memory card accessible data format.

The configuration may further comprise a data memory unit for storing data received through the communication line, a display unit for displaying data reception information when data is stored in the data memory unit, and an input selector for selecting the data to be stored in the memory card from the data once stored in the data memory unit and transferring to the memory card.

In this configuration, all data received through the communication line is once stored in the data memory unit, and the user can check the data reception information in the display unit and select the data to be stored in the memory card, and therefore the image and audio data acquired through the communication line can be securely stored in the memory card.

The scanner may be provided with an infrared ray emitter, and the facsimile apparatus main body may further comprise an infrared ray detector.

Accordingly, the scanner may be detached from the facsimile apparatus main body, and an image on flat surface or a curved surface can be read by the scanner, and the image data can be transferred to the facsimile apparatus, so that the data can be taken in from various types of original documents.

The mode selector may further have a transmission-record mode for feeding the data issued from the first data format transform unit into the communication input and output unit and second data format transform unit.

Accordingly, while transmitting the image data read by the scanner by facsimile, the data can be recorded in the memory card at the same time, and the backup of transmission data can be stored, and the transmitted image data may be later used in image processing directly.

In these examples, a copyright-protected memory card can be used as the memory card.

As a result, the security is excellent, and the copyright of transmitted and received data can be protected as required.

### BRIEF DESCRIPTION OF THE DRAWINGS

FIG. 1 is a perspective view showing an appearance of a facsimile apparatus in an embodiment of the invention.

FIG. 2 is a block diagram showing a configuration of the facsimile apparatus in the embodiment of the invention.

FIG. 3 is a flowchart showing the flow of entire processing and flow of reception mode of the facsimile apparatus in the embodiment of the invention.

FIG. 4 is a flowchart showing the flow of transmission mode of the facsimile apparatus in the embodiment of the invention.

FIG. 5 is a flowchart showing the flow of recording mode of the facsimile apparatus in the embodiment of the invention.

FIG. 6 is a flowchart showing the flow of transmission-record mode of the facsimile apparatus in the embodiment of the invention.

### DESCRIPTION OF THE PREFERRED EMBODIMENT

The applicants hit upon an idea of transmitting stored data directly from a card by providing a facsimile apparatus with a memory card input and output unit, and inserting a memory card therein. This facsimile apparatus will dramatically upgrade the function of the facsimile apparatus and expand the possibility of the facsimile apparatus.

Considering the capability of the facsimile apparatus as image input device, the necessity of storing the image data read by the scanner by using a memory card is also high. This is same as the high necessity of transmitting the image data taken by a digital still camera by using a memory card. Since the facsimile apparatus is provided with a scanner, only if the facsimile apparatus has a function of storing the image on sheet of paper or flat surface into the memory card, the possibility of the facsimile apparatus will be further expanded.

An embodiment of the invention is explained below by referring to the accompanying drawings.

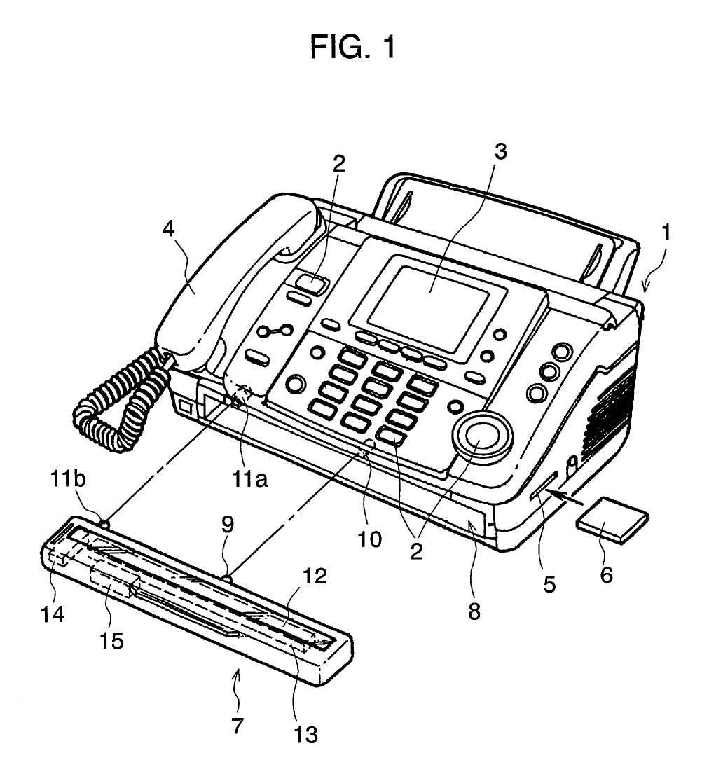

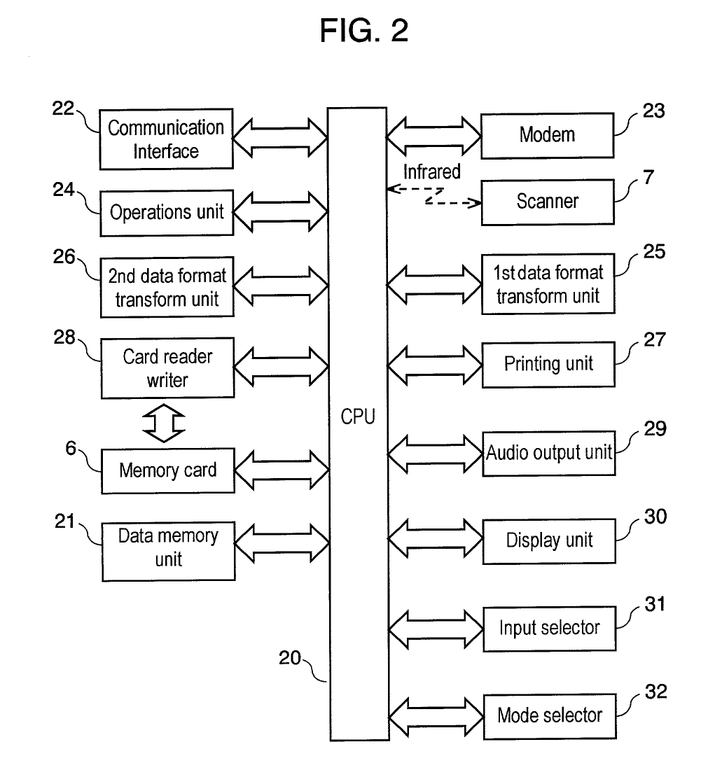

FIG. 1 is a perspective view showing an appearance of a facsimile apparatus in an embodiment of the invention, and FIG. 2 is a block diagram showing a configuration of the facsimile apparatus in the embodiment of the invention.

In FIG. 1, the facsimile apparatus main body 1 comprises an operation unit 2 for calling and other operations, a liquid crystal display 3 for displaying data reception information and others as described below, or checking the image information for facsimile transmission prior to sending or checking the received image information before printing, a handset 4 for making communications, and a card slot 5 of a card reader writer 28 (a memory card input and output unit of the invention as described below) for inserting a memory card 6 and exchanging image information with the memory card 6. This card slot 5 is provided in the card reader writer 28 as the memory card input and output unit of the invention for exchanging image information with the memory card 6. This memory card 6 is preferred to be a memory card of next generation conforming to the copyright protection function demanded by major software contents firms around the world. That is, in a system to be established in future, when the copyright-protected content is received, it cannot be stored unless the memory card is a copyright-protected one. As the memory card, aside from the copyright-protected memory card, various known memory cards conforming to the personal computer standards may be used, and any card incorporating a nonvolatile memory can be used. A scanner 7 is detachably provided in the facsimile apparatus main body 1 for feeding image data from an original document, and a scanner compartment 8 is formed in the facsimile apparatus main body 1 for accommodating the scanner 7. The scanner 7 includes an infrared ray emitter 9 for transferring the read image data to the facsimile apparatus main body 1, and inside of the scanner compartment 8 of the facsimile apparatus main body 1, there is an infrared ray detector 10 disposed at a position corresponding to the infrared ray emitter 9. Current feeders 11a, 11b are terminals provided in the facsimile apparatus main body 1 and scanner 7 respectively for feeding electric power to the scanner 7 when reading the original document, and they contact with each other when the scanner 7 is set in the scanner compartment 8. The infrared ray emitter 9 and infrared ray detector 10 are set at a very close distance, not contacting with each other, when the scanner 7 is put in the scanner compartment 8.

A protective glass 12 is placed on the reading plane of the scanner 7, and a reading unit 13 comprising a unit of color image sensor is disposed in the protective glass 12. A battery 14 incorporated in the scanner 7 supplies electric power when the scanner 7 is detached from the scanner compartment 8 and used for scanning. A scanner control unit 15 controls the scanner 7, and has a memory for storing the read data, and also includes two light sources not shown.

With the scanner 7 installed in the scanner compartment 8, when reading the original document together with the apparatus and transmitting by facsimile, the scanner control unit 15 transfers the read data immediately to the facsimile apparatus main body 1 side. However, when the scanner 7 is detached from the scanner compartment 8 and used alone, the read data is accumulated in the memory of the control unit 15, and when the scanner 7 is put back in the scanner compartment 8, the data is transferred to the facsimile apparatus main body 1 side. Therefore, it is designed to operate if the battery output is small. Thus, since the scanner 7 can be detached from the main body and used, it is easy to use the scanner, and the image data on a flat plane or curve plane can be read clearly, unlike the digital still camera, so that multiple kinds of images can be handled in the memory card.

In FIG. 2, a central control unit (control unit in the invention) 20 comprises a CPU for processing various operations on the basis of the ROM storing the operation program of the entire facsimile apparatus, and a RAM for exchanging data with the CPU, and it is designed to control the operation of the parts of the facsimile apparatus. A data memory unit 21 is for temporarily storing the data received through the communication line, and usually a nonvolatile memory such as flash memory is used, but, if necessary, a hard disk or other memory medium may be used. A communication interface 22 is used for connection between telephone line (not shown) and this facsimile apparatus, exchange of various protocol data, and transmission and reception of data. A modem 23 is used for modulation and demodulation in the process of data exchange with other facsimile apparatus. The communication interface 22 and modem 23 compose the communication input and output unit of the invention. Operation units 24 compose the operation unit 2 in FIG. 1 together with an input selector 31 and a mode selector 32 described below.

A first data format transform unit 25 is to transform the image data entered from the scanner 7 into a facsimile applicable data format, and specifically transforms the RGB image signal into image data of format conforming to, for example, ITU-T T.81 standard when used in color facsimile apparatus, or MH coded data when used in monochromatic facsimile apparatus.

A second data format transform unit 26 is designed to transform mutually between the facsimile applicable data format and memory card accessible data format, and specifically transforms the image data of the format conforming to ITU-T T.81 standard or MH coded data mentioned above into the JFIF (YCbCr color expression) format of TIFF which is the compressed data format of the memory card 6 or JPEG format data of DCF, or vice versa.

To receive distribution of audio data, the second data format transform unit 26 transforms the audio compressed data of MP3 (MPEG Audio Layer 3) data format or AAC (Advanced Audio Coding) data format into data format for memory card 6. By thus transforming, the data stored in the memory card 6 can be immediately reproduced by the personal computer or reproducing apparatus. The format of data that can be entered in the memory card 6 is selected for realizing security or other various functions.

A printing unit 27 prints the received facsimile image data in color printing or monochromatic printing. A card reader writer 28 exchanges data with the memory card 6. An audio output unit 29 converts the transmitted audio data by D/A conversion, and amplifies and issues, and the handset 4 in FIG. 1 is also included herein. A display unit 30 displays the data reception information and various data in the liquid crystal display 3. The operator confirms the data reception information shown on the liquid crystal display 3. Then an input selector 31 selects the data to be stored in the case of the image data or audio data to be stored in the memory card 6, and gives a transfer instruction to the memory card 6. The operation unit 2 shown in FIG. 1 is composed of this input selector 31 and various operation units 24.

A mode selector 32, when desired to store the image data transferred from the scanner 7 into the memory card 6, transmits the format data (for example, compressed data of Lab format of JPEG) conforming to the ITU-T T.81 standard which is the format for facsimile transmission by sending from the first data format transform unit 25 to the communication interface 22, to the second data format transform unit 26, and changes over to the recording mode for transforming into the JFIF (YCbCr color expression) format of TIFF or JPEG format data of DCF. The mode selector 32, together with the input selector 31, composes the operation unit 2 in FIG. 1. The mode selector 32 selects one of (1) transmission mode, (2) recording mode, and (3) transmission-record mode. By selecting one of the three modes, and installing the scanner 7 to assemble into one system, the central control unit 20 recognizes this state, and judges the setting is enough for reading, and various modes are processed immediately.

When the transmission mode (1) is selected, the image data being read by the scanner 7 is transmitted from the first data format transform unit 25 through the communication line. When the recording mode (2) is selected, the image data being read by the scanner 7 is recorded in the memory card 6 by way of the first data format transform unit 25 and second data format transform unit 26. Further, when the transmission-record mode is selected, the image data is transmitted from the first data format transform unit 25 through the communication line, and is at the same time recorded in the memory card 6 by way of the second data format transform unit 26. As a result, the transmission data is backed up, and the image can be processed again after transmission.

As explained above, the first data format transform unit 25 transforms the image data entered from the scanner 7 into the facsimile applicable data format, but instead of this first data format transform unit, a third data format transform unit may be composed to transform into data of the format for the memory card 6. At this time, the mode selector 32 transmits the image data entered from the scanner 7 to the third data format transform unit in transmission mode, and sends the output data from the third data format transform unit into the second data format transform unit 26 serially. Since the data of facsimile applicable format is issued from the second data format transform unit 26, it is transmitted from the modem 23 and communication interface 22. In recording mode, the data issued from the third data format transform unit is sent and stored in the card reader writer 28. In transmission-record mode, transmission mode is executed after recording mode.

By using such third data format transform unit, the primary data format used in the facsimile apparatus, that is, the data format obtained by first converting the format of the image data entered from the scanner 7 is same as the data format used in the memory card, and this data format can be immediately processed by personal computer or the like, and therefore the data entered by the scanner and stored in the memory card can be immediately read and processed by the personal computer without transforming, so that it is very easy to handle. In this case, the user has only to consider the memory card mainly, that is, the content, and henceforth various data processing devices can be easily connected to the facsimile apparatus through the memory card.

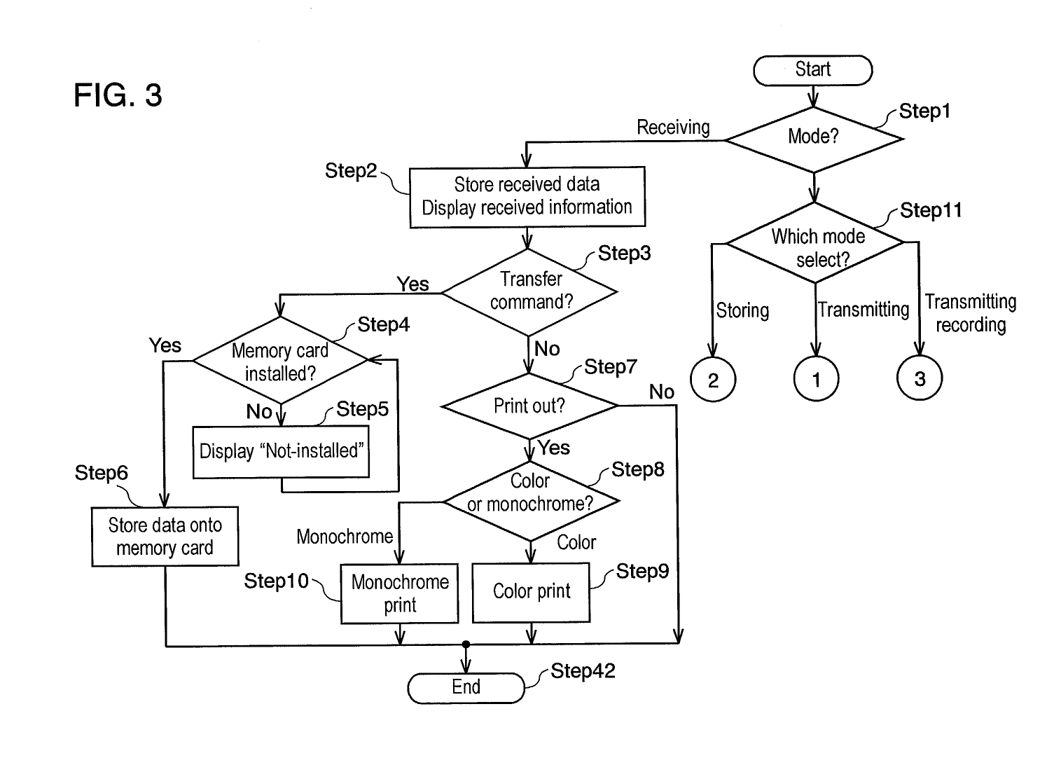

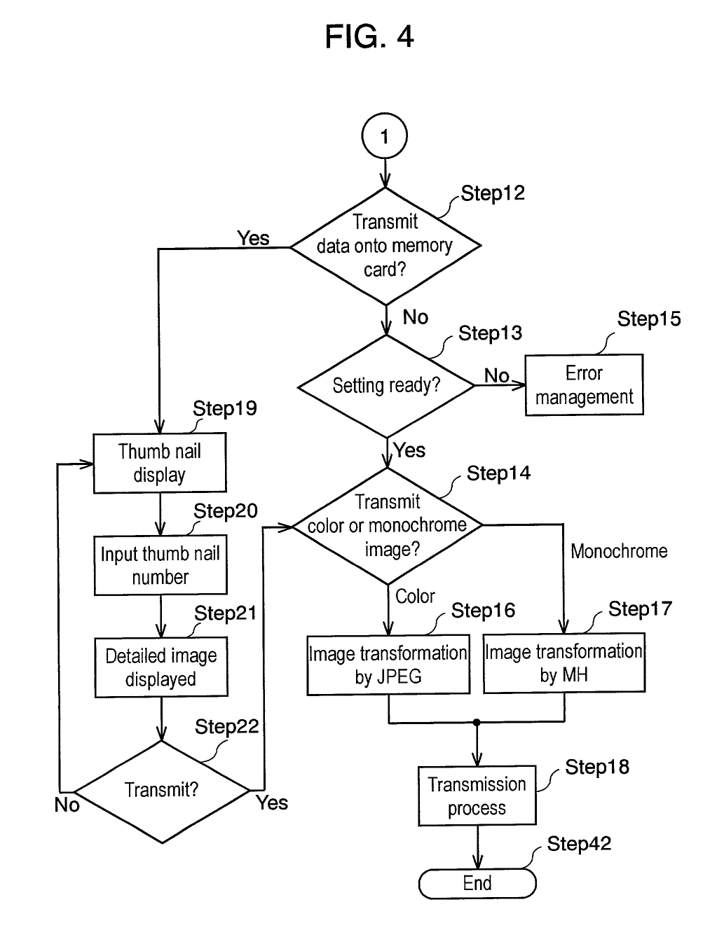

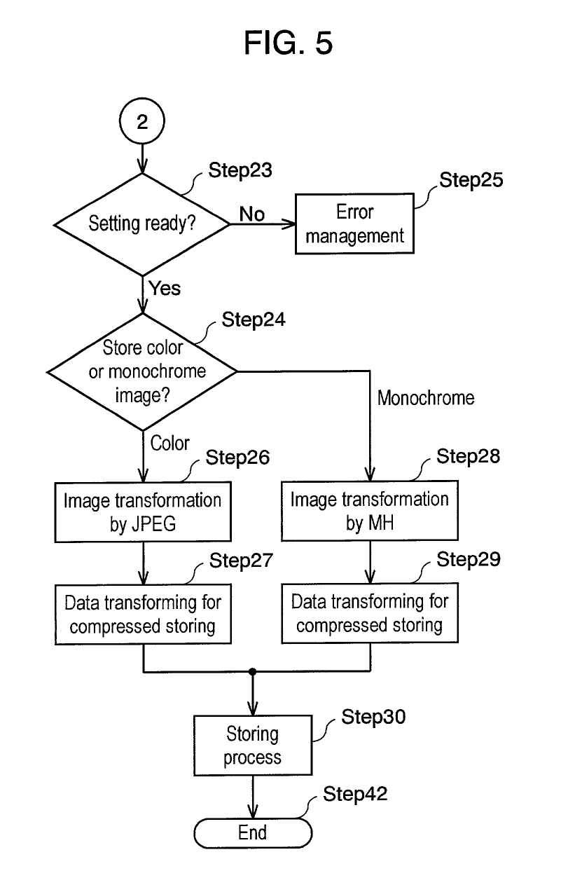

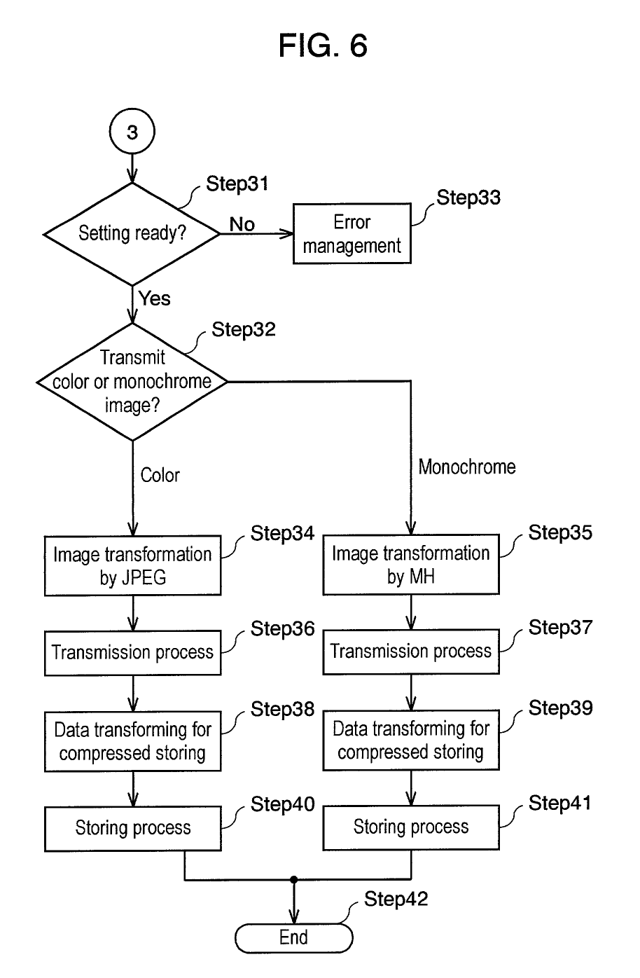

The operation of the facsimile apparatus of the embodiment having such configuration is explained. FIG. 3 is a flowchart showing the flow of entire processing and flow of reception mode of the facsimile apparatus in the embodiment of the invention, FIG. 4 is a flowchart showing the flow of transmission mode of the facsimile apparatus in the embodiment of the invention, FIG. 5 is a flowchart showing the flow of recording mode of the facsimile apparatus in the embodiment of the invention, and FIG. 6 is a flowchart showing the flow of transmission-record mode of the facsimile apparatus in the embodiment of the invention.

First, the data receiving operation is explained. When receiving data, getting into reception mode at step 1 in FIG. 3 and going to step 2, the received data is stored in the data memory unit 21 composed of a flash memory, and when the title (file name) of the data which is the data reception information, or the data is the image data, the display unit 30 shows a thumb nail image in the liquid crystal display 3. When the received data is provided with a flag of copyright protection function such as “Copy prohibited,” this data is also displayed as data reception information.

At step 3, the user checks the data reception information, and selects which data should be transferred to the memory card 6, and a transfer command is sent from the input selector 31. By this input, the central control unit 20 goes to step 4 to recognize if the memory card 6 is inserted in the card reader writer 28 or not, and if the memory card 6 is not installed, it is warned at step 5 by displaying “Not installed” in the liquid crystal display 3. When the memory card 6 is installed, the central control unit 20 goes to step 6, and transfers the specified data in the data memory unit 21 to the memory card 6 according to the input. If the user carelessly manipulates the input selector 31 while the memory card is not installed, and terminates the operation without storing data in the memory card 6, the central control unit 20 waits until the memory card 6 is installed, and transfers the data automatically when installed. At this time, if the received data is different from the memory card accessible data format, the central control unit 20 instructs the data format transform unit to transform it into the accessible data format, and the transformed data is stored in the memory card.

At step 3, if transfer is not instructed to the memory card 6, the user manipulates the input selector 31 and operation units 24 again, and can instruct whether or not to print out the image displayed in the liquid crystal display 3 (step 7).

When printing out, the process goes to step 8, and it is judged whether the image to be printed is monochromatic image or color image, and the color image is printed by the printing unit 27 at step 9, while the monochromatic image is printed by the printing unit 27 at step 10, and then going to step 42, the process is over. If selected not to print out at step 7, the process goes to step 42 to terminate the process.

The transmission process is explained.

In the case of transmission, moving from step 1 to step 11 in FIG. 3, it is checked if the transmission mode is selected, out of transmission, recording and transmission-record modes, by the mode selector 32. When the transmission mode is set, successively going to step 12 in FIG. 4, the user manipulates the mode selector 32 to set the transmission, selecting either the transmission of image stored in the memory card 6, or transmission of image or document read by the scanner 7 such as ordinary facsimile apparatus.

If it is not transmission from the memory card 6, going to step 13, the setting state is judged whether the image read by the scanner 7 can be transferred to the facsimile apparatus main body 1, or the original document is set in the facsimile apparatus main body 1.

If the setting is insufficient, that is, when the scanner 7 is not installed or the original document is not set, going to step 15, a message such “Original not set” is displayed in the liquid crystal display 3, and the error is processed. On the other hand, when the setting is sufficient, going to step 14, the user manipulates the operation units 24 to select either color image transmission or monochromatic image transmission. In the case of color image transmission, the process goes to step 16. At step 16, the original image being read by the scanner 7 is transformed into image data of JPEG format conforming to the ITU-T T.81 of color facsimile standard in the first data format transform unit 25, and it is transmitted to the destination through the modem 23 and communication interface 22 at step 18. In the case of monochromatic image, at step 17, it is transformed into data of MH coding (or MR, MMR, JBIG, etc.), and transmitted at step 18.

On the other hand, when transmission from the memory card 6 is specified at step 12, going to step 19, the central control unit 20 controls the card reader writer 28, and displays a list of images stored in the memory card 6 in the liquid crystal display 3 in a thumb nail format. In this embodiment, the thumb nail format image is displayed in the liquid crystal display 3, but instead of displaying in the liquid crystal display, it may be once printed out by the printing unit 27. Afterwards, the user, in order to specify the image to be transmitted by the displayed thumb nail, can enter the thumb nail number related with the thumb nail at step 20 by manipulating the input selector 31. As a result, the detailed image corresponding to the thumb nail image of the number specified at step 21 can be displayed in the liquid crystal display 3. At step 22, the user observes this image, and finally determines whether to transmit this image or not, and when transmitting, the process goes to step 14. If not transmitting, back to step 19, the thumb nail image is displayed. Although not specifically shown in the flowchart in FIG. 4, an escape can be processed from any step, and after the escape, the process goes to step 42.

The recording process is explained.

In the case of recording mode, as shown in FIG. 5, it is checked if the recording mode is selected at step 11 in FIG. 3. Going to step 23 in FIG. 5, it is judged if possible to transfer the image read by the scanner 7 to the facsimile apparatus main body 1, if the original document is set in the facsimile apparatus main body 1, and if other setting is ready or not.

If the setting is insufficient, for example, if the scanner 7 is not installed or the original document is not set, going to step 25, a message “Original is not set” or the like is displayed in the liquid crystal display 3, and the error is processed. On the other hand, when the setting is sufficient, going to step 24, the user manipulates the operation units 24 to specify whether the image to be recorded is color or monochromatic. In the case of color image, the process goes to step 26. At step 26, the color image is transformed into image data of JPEG format conforming to the color facsimile standard ITU-T T.81 standard by the first data format transform unit 25, and then at step 27, the data is compressed and transformed into the JFIF (YCbCr color expression) format of TIFF or JPEG format data of DCF so as to be entered in the memory card 6 by the second data format transform unit 26. In the case of monochromatic image, at step 28, the data is transformed into MH coding (or MR, MMR, JBIG, etc.), and is similarly compressed and transformed at step 29. When the data is ready to be entered in the memory card 6 at step 27 and step 29, the central control unit 20 records the image data in the memory card 6 through the card reader writer 28, and the recording process is terminated at step 42.

Finally, the transmission-record process is explained.

In the case of transmission-record mode, at step 11 in FIG. 3, it is judged if the transmission-record mode is selected or not. Going to step 31 in FIG. 6, it is judged if possible to transfer the image read by the scanner 7 to the facsimile apparatus main body 1, if the original document is set in the facsimile apparatus main body 1, and if other setting is ready or not.

If the setting is insufficient, for example, if the scanner 7 is not installed or the original document is not set, going to step 33, a message “Original is not set” or the like is displayed in the liquid crystal display 3, and the error is processed. On the other hand, when the setting is sufficient, going to step 32, the user manipulates the operation units 24 to specify whether the image to be recorded is color or monochromatic. In the case of color image, the process goes to step 34. At step 34, the color image is transformed into image data of JPEG format conforming to the color facsimile standard ITU-T T.81 standard by the first data format transform unit 25.

Going to step 36, the data is transmitted, and at step 38, the data is compressed and transformed by the second data format transform unit 26. The transformed image data is stored in the memory card 6 by the central control unit 20 through the card reader writer 28, and the transmission-record process is terminated at step 42.

When the monochromatic image is selected at step 32, going to step 35, the data is transformed into ME coding (or MR, MMR, JBIG, etc.) by the first data format transform unit 25. Going to step 37, the data is transmitted, and is compressed and transformed by the second data format transform unit 26 at step 39, and the data is stored in the memory card 6 at step 41 by the central control unit 20 through the card reader writer 28, and the transmission-record process is terminated at step 42.

As explained herein, according to the facsimile apparatus of the invention, the data transmitted through a communication line is once stored securely in the internal data memory unit, and the reception information of the received data is displayed in the display unit, and the user operates and selects necessary data and transfer to the memory card, and therefore handling is easy and the data can be securely stored in the memory card.

The facsimile apparatus of the invention can not only transmit the image data entered from the scanner, same as the image data taken by a digital still camera, easily by facsimile at high picture quality, but also record the image data entered from the scanner in the memory card, or record the data to be transmitted in the memory card in the recording mode or transmission-record mode. The data format of the received data and the format of the memory card can be freely transformed, and it is not necessary to use a personal computer or the like for transforming the data format, and moreover, if necessary, the copyright can be protected, so that a very convenient facsimile apparatus can be presented.

What is claimed is:

1. A facsimile apparatus comprising:
a) a communication input and output unit for transmitting and receiving data through a communication line,
b) a data memory unit for storing data received in said communication input and output unit through the communication line,
c) a display unit for displaying data reception information when data is stored in said data memory unit,
d) a memory card input and output unit for loading a memory card and capable of writing data into the memory card and reading data from the memory card, and
e) an input selector for selecting data to be stored in the memory card from data once stored in said data memory unit and transferring the data to the memory card.

2. The facsimile apparatus of claim 1 further comprising a control unit,
wherein when the memory card is not installed in said memory card input and output unit, it is recognized by said control unit, and “Not installed” is displayed in said display unit.

3. The facsimile apparatus of claim 2,
wherein in the case of input of transfer of data from said input selector, if the memory card is not installed in said memory card input and output unit, when the memory card is installed and it is recognized by said control unit, the data to be transferred is transferred into the memory card.

4. The facsimile apparatus of claim 1 further comprising:
a data format transform unit for transforming a data into an applicable data format if the data received in said facsimile apparatus is not accessible to the memory card.

5. The facsimile apparatus of claim 4,
wherein the memory card accessible data format is JFIF (YCbCr color expression) data format of TIFF.

6. The facsimile apparatus of claim 4,
wherein the memory card is a copyright-protected memory card.

7. The facsimile apparatus of claim 4,
wherein said data format transform unit transforms the data stored in the memory card into a data format to be transmitted by a facsimile, and the transformed data is transmitted through the communication line.

8. A facsimile apparatus comprising:
a) a communication input and output unit for transmitting and receiving data through a communication line,
b) a scanner for reading an original document or image data,
c) a memory card input and output unit for loading a memory card and capable of writing data into the memory card and reading data from the memory card,
d) a first data format transform unit for transforming input image data from the scanner into a facsimile applicable data format,
e) a second data format transform unit for transforming the data format mutually between the facsimile applicable data format and a memory card accessible data format, and
f) a mode selector for sending the data issued from the first data format transform unit to the communication input and output unit in transmission mode, and feeding the data output from the first data format transform unit into the second data format transform unit in recording mode.

9. A facsimile apparatus comprising:
a) a communication input and output unit for transmitting and receiving data through a communication line,
b) a scanner for reading an original document or image data,
c) a memory card input and output unit for loading a memory card and capable of writing data into the memory card and reading data from the memory card,
d) a first data format transform unit for transforming input image data from the scanner into a memory card accessible data format,
e) a second data format transform unit for transforming the data format mutually between a facsimile applicable data format and the memory card accessible data format, and
f) a mode selector for feeding the data output from the first data format transform unit to the second data format transform unit in transmission mode, and sending the data output from the first data format transform unit into the memory card input and output unit in recording mode.

10. The facsimile apparatus of claim 8 further comprising:
a data memory unit for storing data received through the communication line,
a display unit for displaying data reception information when data is stored in the data memory unit, and
an input selector for selecting data to be stored in the memory card from data once stored in the data memory unit and transferring the data to the memory card.

11. The facsimile apparatus of claim 9 further comprising:
a data memory unit for storing data received through the communication line,
a display unit for displaying data reception information when data is stored in the data memory unit, and
an input selector for selecting data to be stored in the memory card from data once stored in the data memory unit and transferring the data to the memory card.

12. The facsimile apparatus of claim 10,
wherein said scanner is provided with an infrared ray emitter, and the facsimile apparatus main body further comprises an infrared ray detector.

13. The facsimile apparatus of claim 11,
wherein said scanner is provided with an infrared ray emitter, and the facsimile apparatus main body further comprises an infrared ray detector.

14. The facsimile apparatus of claim 10,
wherein said mode selector further includes a transmission-record mode for feeding the data output from said first data format transform unit into the communication input and output unit and said second data format transform unit.

15. The facsimile apparatus of claim 11,
wherein said mode selector further includes a transmission-record mode for feeding the data output from said first data format transform unit into the communication input and output unit and said second data format transform unit.

16. The facsimile apparatus of claim 10, wherein the memory card is a copyright-protected memory card.

17. The facsimile apparatus of claim 11, wherein the memory card is a copyright-protected memory card.

18. The facsimile apparatus of claim 1 further comprising: a nonvolatile memory card detachable from said facsimile apparatus.

19. The facsimile apparatus of claim 8 further comprising: a nonvolatile memory card detachable from said facsimile apparatus.

20. The facsimile apparatus of claim 9 further comprising: a nonvolatile memory card detachable from said facsimile apparatus.
